(19) United States
(12) Patent Application Publication
(10) Pub. No.: US 2024/0316440 A1
(43) Pub. Date: Sep. 26, 2024

(54) TECHNOLOGIES FOR TRANSPORTATION

(71) Applicant: Aaron Benjamin Aders, Garden Grove, CA (US)

(72) Inventor: Aaron Benjamin Aders, Garden Grove, CA (US)

(21) Appl. No.: 18/693,104

(22) PCT Filed: Sep. 23, 2022
(86) PCT No.: PCT/US22/44500

§ 371 Date: Mar. 18, 2024

Related U.S. Application Data
(60) Provisional application No. 63/248,018, filed on Sep. 24, 2021.

(51) Int. Cl. A63C 17/12; A63C 17/08

(52) U.S. Cl. CPC A63C 17/12; A63C 17/08; A63C 2203/12; A63C 2203/18; A63C 2203/24

(57) ABSTRACT

A platform that does not have any trucks coupled thereto and configured for a rider to ride thereon; a mount coupled to the platform, wherein the mount is configured to freely rotate 360 degrees about a first axis relative to the platform; a motor coupled to the mount and configured to operate at a rotational speed; a roller coupled to the motor such that the motor can drive the roller about a second axis distinct from the first axis relative to the platform; a power source coupled to the platform and powering the motor; a controller powered by the power source; and an IMU coupled to the platform or the mount and powered by the power source, wherein the IMU obtains a reading while the roller is rolling as the rider rides on the platform and sends the reading to the controller such that the controller adjusts the rotational speed.

### CROSS-REFERENCE TO RELATED PATENT APPLICATION

This patent application claims a benefit of priority to U.S. Provisional Patent Application No. 63/248,018 filed 24 Sep. 2021; which is incorporated by reference herein for all purposes.

### TECHNICAL FIELD

Generally, this disclosure relates to transportation. More particularly, this disclosure relates to motorized transportation.

### BACKGROUND

In this disclosure, where a document, an act, and/or an item of knowledge is referred to and/or discussed, then such reference and/or discussion is not an admission that the document, the act, and/or the item of knowledge and/or any combination thereof was at a priority date, publicly available, known to general public, part of common general knowledge, and/or otherwise constitutes prior art under any applicable statutory provisions; and/or is known to be relevant to an attempt to solve any problem with which this disclosure may be concerned with. Further, nothing is disclaimed.

A rider may desire to ride a board having a pair of trucks. However, this configuration is technologically problematic for several reasons. For example, the pair of trucks may reduce maneuverability of the board. To deal with this constraint, the board may lack the pair of trucks, but have a single wheel. However, this configuration is also technologically problematic because lateral movement of the board is difficult, if not impossible, to attain, while also allowing the rider to balance on the board on at least two axis (e.g. pitch and roll) while riding.

### SUMMARY

This disclosure at least partially addresses at least one technological problem noted above. However, this disclosure can prove useful to other technical areas.

In an embodiment, a device comprising: a platform (101) that does not have any trucks coupled thereto and configured for a rider to ride thereon; a mount (131) coupled to the platform, wherein the mount is configured to freely rotate 360 degrees about a first axis relative to the platform; a motor (129) coupled to the mount and configured to operate at a rotational speed; a roller (130) coupled to the motor such that the motor can drive the roller about a second axis distinct from the first axis relative to the platform; a power source (102) coupled to the platform and powering the motor; a controller (103) powered by the power source; and an inertial measurement unit (IMU) (105) coupled to the platform or the mount and powered by the power source, wherein the IMU is configured to obtain a reading while the roller is rolling as the rider rides on the platform and send the reading to the controller while the roller is rolling as the rider rides on the platform such that the controller adjusts the rotational speed to assist the rider to balance on the platform while the roller is rolling.

In an embodiment, a method comprising: sending a device to a rider, wherein the device comprising: a platform (101) that does not have any trucks coupled thereto and configured for a rider to ride thereon; a mount (131) coupled to the platform, wherein the mount is configured to freely rotate 360 degrees about a first axis relative to the platform; a motor (129) coupled to the mount and configured to operate at a rotational speed; a roller (130) coupled to the motor such that the motor can drive the roller about a second axis distinct from the first axis relative to the platform; a power source (102) coupled to the platform and powering the motor; a controller (103) powered by the power source; and an inertial measurement unit (IMU) (105) coupled to the platform or the mount and powered by the power source; and instructing the rider to ride the platform such that the IMU obtains a reading while the roller is rolling as the rider rides on the platform and sends the reading to the controller while the roller is rolling as the rider rides on the platform such that the controller adjusts the rotational speed to assist the rider to balance on the platform while the roller is rolling.

In an embodiment, a method comprising: causing a rider to receive a device comprising: a platform (101) that does not have any trucks coupled thereto and configured for a rider to ride thereon; a mount (131) coupled to the platform, wherein the mount is configured to freely rotate 360 degrees about a first axis relative to the platform; a motor (129) coupled to the mount and configured to operate at a rotational speed; a roller (130) coupled to the motor such that the motor can drive the roller about a second axis distinct from the first axis relative to the platform; a power source (102) coupled to the platform and powering the motor; a controller (103) powered by the power source; and an inertial measurement unit (IMU) (105) coupled to the platform or the mount and powered by the power source; and causing the rider to operate the device such that the IMU obtains a reading while the roller is rolling as the rider rides on the platform and send the reading to the controller while the roller is rolling as the rider rides on the platform such that the controller adjusts the rotational speed to assist the rider to balance on the platform while the roller is rolling.

In an embodiment, a method comprising: accessing a device comprising: a platform (101) that does not have any trucks coupled thereto and configured for a rider to ride thereon; a mount (131) coupled to the platform, wherein the mount is configured to freely rotate 360 degrees about a first axis relative to the platform; a motor (129) coupled to the mount and configured to operate at a rotational speed; a roller (130) coupled to the motor such that the motor can drive the roller about a second axis distinct from the first axis relative to the platform; a power source (102) coupled to the platform and powering the motor; a controller (103) powered by the power source; and an inertial measurement unit (IMU) (105) coupled to the platform or the mount and powered by the power source; and riding the device such that the IMU obtains a reading while the roller is rolling as the rider rides on the platform and sends the reading to the controller while the roller is rolling as the rider rides on the platform such that the controller adjusts the rotational speed to assist the rider to balance on the platform while the roller is rolling.

In an embodiment, a method comprising: manufacturing a device comprising: a platform (101) that does not have any trucks coupled thereto and configured for a rider to ride thereon; a mount (131) coupled to the platform, wherein the mount is configured to freely rotate 360 degrees about a first axis relative to the platform; a motor (129) coupled to the mount and configured to operate at a rotational speed; a roller (130) coupled to the motor such that the motor can drive the roller about a second axis distinct from the first axis relative to the platform; a power source (102) coupled to the platform and powering the motor; a controller (103) powered by the power source; and an inertial measurement unit (IMU) (105) coupled to the platform or the mount and powered by the power source, wherein the IMU is configured to obtain a reading while the roller is rolling as the rider rides on the platform and send the reading to the controller while the roller is rolling as the rider rides on the platform such that the controller adjusts the rotational speed to assist the rider to balance on the platform while the roller is rolling.

In an embodiment, a device comprises: a vehicle having a roller.

In an embodiment, a method comprises: manufacturing a vehicle having a roller.

In an embodiment, a method comprises: supplying a vehicle having a roller to a rider.

In an embodiment, a method comprises: causing a rider to operate a vehicle having a roller.

This disclosure may be embodied in various forms illustrated in accompanying drawings. However, these drawings are illustrative and variations are contemplated as being part of this disclosure, limited only by claims.

### DESCRIPTION OF DRAWINGS

The accompanying drawings illustrate example embodiments of this disclosure. Such drawings are not to be construed as necessarily limiting this disclosure. Like numbers and/or similar numbering scheme can refer to like and/or similar elements throughout.

FIG. 1 shows a lateral side view an example embodiment of a vehicle according to this disclosure.

FIG. 2 shows a frontal view or a rear view of an example embodiment of a vehicle according to this disclosure.

FIG. 3 shows a top view in four configurations of an example embodiment of a vehicle according to this disclosure.

FIG. 4 shows an example embodiment of a block diagram of electrical components of a vehicle according to this disclosure.

FIG. 5 shows a flowchart of a method performed by and/or in conjunction with a vehicle according to this disclosure.

FIG. 6 shows an example embodiment of a vehicle in a second state according to this disclosure.

FIG. 7 shows an example embodiment of a vehicle in a third state according to this disclosure.

FIG. 8 shows an example embodiment of a vehicle in a fourth state according to this disclosure.

FIG. 9 shows an example embodiment of a vehicle in a fifth state according to this disclosure.

FIG. 10 shows an example embodiment of a vehicle in a sixth state according to this disclosure.

FIG. 11 shows an example embodiment of a vehicle in a seventh state according to this disclosure.

FIG. 12 shows an example embodiment of a vehicle in an eighth state according to this disclosure.

FIG. 13 shows an example embodiment of a vehicle in a ninth state according to this disclosure.

FIG. 14 shows an example embodiment of a vehicle in a tenth state according to this disclosure.

FIG. 15 shows an example embodiment of a vehicle in an eleventh state according to this disclosure.

FIG. 16 shows an example embodiment of a vehicle in a twelfth state according to this disclosure.

FIG. 17 shows an exploded view and an assembled view of an example embodiment of a motor assembly in a first state according to this disclosure.

FIG. 18 shows an exploded view and an assembled view of an example embodiment of a motor assembly in a second state according to this disclosure.

FIG. 19 shows an example embodiment of a vehicle in movement according to this disclosure.

FIG. 20 shows an example embodiment of a vehicle in movement according to this disclosure.

FIG. 21 shows an example embodiment of a vehicle according to this disclosure.

### DETAILED DESCRIPTION

This disclosure is now described more fully with reference to the drawings, in which some embodiments of this disclosure are shown. This disclosure may, however, be embodied in many different forms and should not be construed as necessarily being limited to various embodiments disclosed herein. Rather, these embodiments are provided so that this disclosure is thorough and complete, and fully conveys various concepts of this disclosure to skilled artisans. Note that like numbers or similar numbering schemes can refer to like or similar elements throughout.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

As used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of the foregoing instances. For example, X includes A or B can mean X can include A, X can include B, and X can include A and B, unless specified otherwise or clear from context.

As used herein, each of singular terms “a,” “an,” and “the” is intended to include a plural form (e.g., two, three, four, five, six, seven, eight, nine, ten, tens, hundreds, thousands, millions) as well, including intermediate whole or decimal forms (e.g., 0.0, 0.00, 0.000), unless context clearly indicates otherwise. Likewise, each of singular terms “a,” “an,” and “the” shall mean “one or more,” even though a phrase “one or more” may also be used herein.

As used herein, each of terms “comprises,” “includes,” or “comprising,” “including” specify a presence of stated features, integers, steps, operations, elements, or components, but do not preclude a presence or addition of one or more other features, integers, steps, operations, elements, components, or groups thereof.

As used herein, when this disclosure states herein that something is “based on” something else, then such statement refers to a basis which may be based on one or more other things as well. In other words, unless expressly indicated otherwise, as used herein “based on” inclusively means “based at least in part on” or “based at least partially on.”

As used herein, terms, such as “then,” “next,” or other similar forms are not intended to limit an order of steps. Rather, these terms are simply used to guide a reader through this disclosure. Although process flow diagrams may describe some operations as a sequential process, many of those operations can be performed in parallel or concurrently. In addition, the order of operations may be re-arranged.

As used herein, a term “response” or “responsive” are intended to include a machine-sourced action or inaction, such as an input (e.g., local, remote), or a user-sourced action or inaction, such as an input (e.g., via user input device).

As used herein, a term “about” or “substantially” refers to a +/−10% variation from a nominal value/term.

As used herein, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

Although various terms, such as first, second, third, and so forth can be used herein to describe various elements, components, regions, layers, or sections, note that these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section, without departing from this disclosure.

Unless otherwise defined, all terms (including technical and scientific terms) used herein have a same meaning as commonly understood by skilled artisans to which this disclosure belongs. These terms, such as those defined in commonly used dictionaries, should be interpreted as having a meaning that is consistent with their meaning in context of relevant art and should not be interpreted in an idealized or overly formal sense, unless expressly so defined herein.

Example embodiments of this disclosure are described herein with reference to illustrations of idealized embodiments (and intermediate structures) of this disclosure. As such, variations from various illustrated shapes as a result, for example, of manufacturing techniques or tolerances, are to be expected. Thus, various example embodiments of this disclosure should not be construed as necessarily limited to various particular shapes of regions illustrated herein, but are to include deviations in shapes that result, for example, from manufacturing.

Features or functionality described with respect to certain embodiments may be combined and sub-combined in or with various other embodiments. Also, different aspects, components, or elements of embodiments, as disclosed herein, may be combined and sub-combined in a similar manner as well. Further, some embodiments, whether individually or collectively, may be components of a larger system, wherein other procedures may take precedence over or otherwise modify their application. Additionally, a number of steps may be required before, after, or concurrently with embodiments, as disclosed herein. Note that any or all methods or processes, as disclosed herein, can be at least partially performed via at least one entity or actor in any manner.

As used herein, a term “or others,” “combination”, “combinatory,” or “combinations thereof” refers to all permutations and combinations of listed items preceding that term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of a item or term, such as BB, AAA, AB, BBC, AAABCCCC, CBBAAA, CABABB, and so forth. Skilled artisans understand that typically there is no limit on a number of items or terms in any combination, unless otherwise apparent from the context.

Any or all elements, as disclosed herein, can be formed from a same, structurally continuous piece, such as being unitary, or be separately manufactured or connected, such as being an assembly or modules. Any or all elements, as disclosed herein, can be manufactured via any manufacturing processes, whether additive manufacturing, subtractive manufacturing, or any other types of manufacturing. For example, some manufacturing processes include three dimensional (3D) printing, laser cutting, computer numerical control routing, milling, pressing, stamping, vacuum forming, hydroforming, injection molding, lithography, and so forth.

Hereby, all issued patents, published patent applications, and non-patent publications that are mentioned or referred to in this disclosure are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

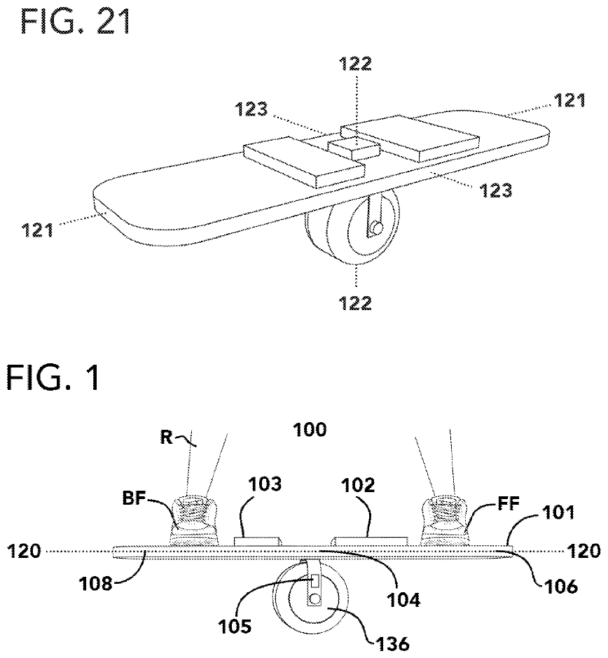

FIG. 1 shows a lateral side view of an example embodiment of a vehicle according to this disclosure. In particular, there is a vehicle allowing a rider to balance thereon on at least two axis (e.g. pitch and roll, yaw and pitch, roll and yaw, pitch, roll, and yaw) while riding, as disclosed herein. The vehicle includes a board 100 including a platform 101 which comprises a center portion 104, a front portion 106, and a rear portion 108. The platform 101 comprises at least one of plastic, metal, rubber, wood, and glass, or any combinations thereof. In some embodiments, the front portion 106 may be sufficiently different in at least one of size and shape from the rear portion 108 such that a rider R can easily visually distinguish therebetween, but in other embodiments, the front portion 106 may be not sufficiently different in at least one of size and shape from the rear portion 108 such that a rider R can easily visually distinguish therebetween. Also, in some embodiments, the platform 101 may be at least one of wider or longer than a conventional skateboard platform, where the conventional skateboard platform may be at least from about 7 inches to about 9 inches wide and from about 31 inches to about 34 inches long. For example, the platform 101 can be about 10 inches wide and about 40 inches long, although other dimensions are possible, as needed.

In some embodiments, the platform 101 does not have any trucks (e.g., skateboard trucks) coupled (e.g., mechanically, electrically) thereto. However, in other embodiments, the platform 101 may have at least one truck (e.g., a skateboard truck) coupled thereto (e.g., mechanically, electrically).

The board 100 includes a power source 102 which provides energy to a motor such that the motor may be able to propel the board 100. The source 102 comprises at least one of plastic, metal, rubber, wood, and glass, or any combinations thereof. The source 102 may be an engine, a motor, a battery (e.g. a rechargeable battery), a fuel tank, a photovoltaic cell, a capacitor, or another power source. For example, the fuel tank can contain gasoline which may be combusted in the engine such that the engine powers the motor to propel the board 100. The source 102 can be rechargeable whether in a wireless manner, such as via induction, and/or a wired manner, such as via a line. The source 102 may be secured to the platform 101, centered on an upper side of the platform 101. The source 102 may be secured to the platform 101 via fastening, but in other embodiments, the source 102 may be secured to the platform 101 via nailing, adhering, mating, interlocking, bolting, clamping, or any combinations thereof. In yet other embodiments, the source 102 may be secured to the platform 101, centered on a lower side of the platform 101. In other embodiments, the source 102 may not be centered, such as in the front portion 106 and/or the rear portion 108. In still other embodiments, the source 102 may be secured inside platform 101. Note that more than one source 102 can be used in any manner, whether powering a motors in any manner, whether synchronously and/or asynchronously, independently and/or dependently, in one manner and/or in different manners, and/or in any type of correspondence, such as one-to-one, many-to-many, one-to-many, and/or many-to-one.

In one mode of operation, a rider R stands on the platform 101 such that the rider's R feet are in a stance similar to that used for snowboarding, surfing, or skateboarding. The rider R stands sideways with a back foot BF roughly perpendicular or at a varying angle to the line 120 and a front foot FF being roughly perpendicular or at a varying angle to the line. This stance allows the rider R to easily shift the rider's R weight onto the rider's R toes or onto the rider's R heels. However, note that the rider's R feet can be at any angle, as measured from the line 120, as many riders have their own stance preferences with known angles. The rider R can also move freely about the upper side of the platform 101, assuming different stances for different maneuvers. As with a conventional skateboard, the front portion 106 and the rear portion 108 may angle upwards from the platform 101. Via transferring the rider's R weight to the front portion 106 or the rear portion 108, the rider R can perform numerous tricks and maneuvers where part or all of the board 100 becomes elevated from a ground surface. Note that the board 100 can ride forwards, backwards, or laterally, which may be controlled by the rider R, as explained herein.

The board 100 further comprises a motor assembly 136 secured to the platform 101, such as via fastening, adhering, mating, interlocking, or other suitable techniques. For example, there may be a single motor assembly 136 secured to the platform 101, or there may be at least two (e.g., two, three, four, or more) or only two motor assemblies 136 secured to the platform 101. The motor assembly 136 may be configured to rotate 360 degrees with respect to the platform 101. The motor assembly 136 may be configured to be elastically biased, such as via a spring, for instance a coiled spring, while constantly contacting the ground surface and self-aligning with a direction of force applied onto the platform 101 during riding. More particularly, the motor assembly 136 may be elastically biased, such as via a spring, to self-align along the line 120, pointed either forward towards the front portion 106 or backward towards the rear portion 108, without interfering with motor-powered operation of the motor assembly 136. Such bias simulates a natural tracking tendency of a ski and/or a snowboard, while enhancing rider R control. Also, note that the bias may be sufficiently strong to add rider R control, yet configured such that the rider R may be substantially precluded from rotating the platform 101 into sideways riding. In some embodiments, the bias manifests via a roller being attached to a frame, while rotating about a horizontal axis of rotation, with a cam follower being pivotally coupled to the frame and including a torsion spring. The cam follower comprises a bearing. The cam follower may be forced by an elastic member, such as a spring, to be positioned against a cam which may be fixed relative to the platform 101, which causes the frame to rotate to a position of least force between the cam and the cam follower. Accordingly, a bias profile may be established via adjusting at least one of a cam shape and a spring force on the cam follower. One example of the cam may be a pair of M-shaped curves symmetrically coupled to each other at their ends at a pair of apexes. However, note that biasing is optional and the motor assembly 136 may not be configured to be biased or elastically biased. In some embodiments, the motor assembly 136 comprises the source 102.

Although the motor assembly 136 is described in context of the board 100, the motor assembly 136 can be applied to other environments, vehicles, functions, and/or structures, at least in a manner as described herein, such as in a luggage item, a suitcase, a travel bag, a roller skate, an industrial equipment device, a material handling equipment item, a furniture item, a toy, a cart, a robot, a wheelchair, a medical device, a stretcher, a bed, a gurney, a chair, a table, a shopping cart, a platform truck, a tow line in a plant, a pallet, a skid, a video game console, a computer, and/or a board, whether land, aerial, and/or marine, whether manned and/or unmanned, whether for recreation, construction, military, industrial, law enforcement, or medical purposes.

The board 100 includes a controller 103 is configured to control the speed of the motor assembly 136. This speed may be set by a remote control 140, or a balance control algorithm, or a combination of both remote control 140 and balance control algorithm. For example, this speed may be set by the remote control 140. For example, the speed may be set by the balance control algorithm. For example, this speed may be set by a hybrid approach of using the remote control 140 and the balance control algorithm.

The board includes a sensor(s) 105, whether analog or digital. The sensor(s) 105 may be powered by the power source 102 and may sense at least one of a yaw, a pitch, a roll, a shock, or a magnetic field of the platform 101. The sensor(s) 105 is electrically coupled (e.g., connected, wired) with the controller 103. Note that the sensor(s) 105 can be a single sensor 105 sensing all of such attributes (e.g., a sensing assembly) or the sensor(s) 105 can be a group of sensor(s) 105 where at least one sensor(s) 105 senses at least two of such attributes or where each sensor(s) 105 is task-dedicated and senses only one of such attributes. For example, there can be the group of sensor(s) 105 where one sensor(s) 105 senses the yaw, one sensor(s) 105 senses the pitch, one sensor(s) 105 senses the roll, one sensor(s) 105 senses the shock, and one sensor senses the magnetic field. For example, there can be the group of sensor(s) 105 where one sensor(s) 105 senses the yaw and the pitch and one sensor(s) 105 senses the roll, one sensor(s) 105 senses the shock, and one sensor senses the magnetic field. Note that the sensor(s) 105 or the group of sensor(s) 105 may sense all of such attributes or less than all of such attributes. Likewise, note that a single sensor(s) 105 may sense any combinations of at least two of such attributes.

The balance control algorithm may use the data generated by sensor(s) 105 to set a speed for motor assembly 136. The sensor(s) 105 may assist or better assist the rider R to balance and ride the board 100 similar to snowboarding, surfing, or skateboarding. The sensor(s) 105 can include inertial measurement units, magnetic sensors, pressure sensors, gyroscopes, accelerometers, rotary encoders, optical encoders or other electro-mechanical systems or units that measure movement, tilt, roll, yaw of the platform 101 or the mount 131.

Active balancing (or self-stabilization) of the board 100 may be achieved through the use of a feedback control loop or mechanism, which may be implemented in the electrical components. The feedback control mechanism may include sensor(s) 105 electrically or logically connected to (and/or included in) controller 103. As explained in context of FIGS. 1-10, the board 100 may provide active balancing in the roll axis. Likewise, as explained in context of FIGS. 1-10, the board 100 may provide active balancing in the tilt axis, either alone or together with balancing in the roll axis. Roller 130 in motor assembly 136 may be wide enough in the heel-toe direction (e.g. in a direction perpendicular to roll axis 121) so that the rider can balance themselves in the heel-toe direction using their own balance. The roller 130 may have a profile such that the rider can lean the board 100 over an edge of the roller 130 (and/or pivot the board 100 about the roll axis 121 and/or yaw axis 122 through heel and/or toe pressure to turn or ‘corner’ board 100).

The feedback control mechanism may include a Proportional-Integral-Derivative (PID) control scheme using a gyro (e.g., a gyro 119) and/or an accelerometer (e.g., an accelerometer 118). The gyro 119 may be configured to measure a pivot of platform 101 about the pitch axis 123. The gyro 119 and the accelerometer 118 may be collectively configured to estimate (or measure or sense or determine) a lean angle of the platform 101, such as an orientation of the platform 101 about the pitch, roll and yaw axes. In some embodiments, the gyro 119 and the accelerometer 118 may be collectively configured to sense orientation information sufficient to estimate the lean angle of the platform 101 including a pivot about the pitch, roll and yaw axis.

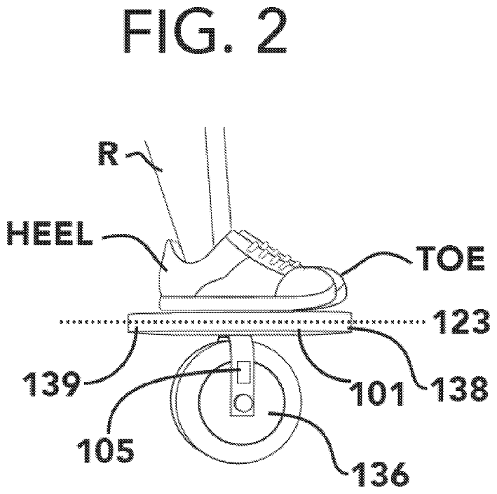

As mentioned above, orientation information of the platform 101 or the mount 131 may be measured (or sensed) by the gyro 119 and/or the accelerometer 118. For example, the board 100 may utilize the controller 103 to obtain measured data from the gyro 119 and the accelerometer 118 to balance or better balance the rider riding the board along at least two different axis (e.g. pitch and roll, pitch and yaw, roll and yaw) of the platform 101 or the mount 131. For example, the board 100 may include a rotary encoder to assist with such balancing, as further described in context of FIGS. 2-10.

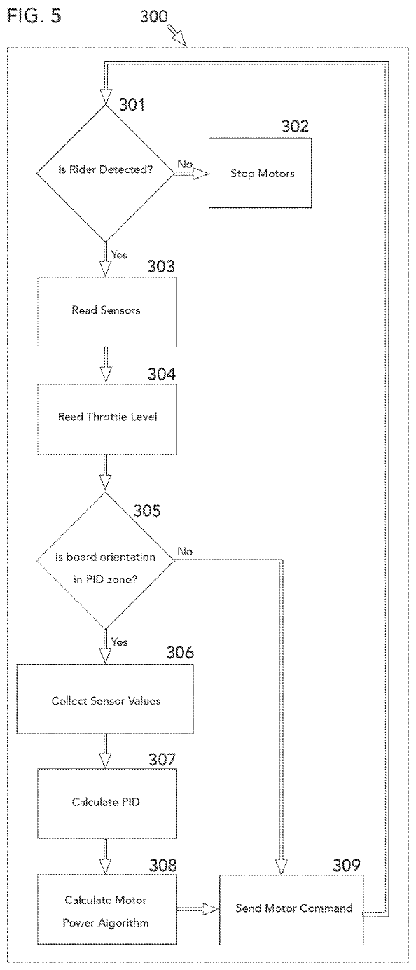

For example, the respective measurements (or sense signals) from the gyro 119 and the accelerometer 118 may be combined using a complementary filter or Kalman filter to estimate a lean angle of the platform 101 (e.g., a pivot of the platform 101 about the pitch, roll, and/or yaw axes, with a pivot about the pitch axis 123 corresponding to a pitch angle, a pivot about the roll axis 121 corresponding to a roll or heel-toe angle, and a pivot about the yaw axis 122 corresponding to a yaw angle) or the mount 131 while filtering out data for impacts of bumps, road texture and disturbances due to steering inputs. For example, the gyro 119 and the accelerometer 118 may be connected (e.g., wired) to a microcontroller 117, which may be configured to correspondingly measure movement of the platform 101 or the mount 131 about and along the respective pitch, roll, and yaw axes (see FIG. 1). Alternatively, the board 100 may include any suitable sensor and feedback control loop configured to self-stabilize the platform 101 or the mount 131, such as a 1-axis gyro configured to measure a pivot of the platform 101 or the mount 131 about the pitch axis 123, a 1-axis accelerometer configured to measure a gravity vector for the platform 101 or the mount 131, and/or any other suitable feedback control loop, such as a closed-loop transfer function. Alternatively, the board 100 may include any suitable sensor and feedback control loop configured to self-stabilize the platform 101 or the mount 131, such as a 1-axis gyro configured to measure a pivot of the platform 101 or the mount 131 about the roll axis 121, a 1-axis accelerometer configured to measure a gravity vector for the platform 101 or the mount 131, and/or any other suitable feedback control loop, such as a closed-loop transfer function. However, additional accelerometer and gyro axes may allow improved performance and functionality, such as detecting if the board 100 has rolled over on its side or if the rider may be making a turn. Certain modifications to or configurations of the PID may enable a loop for other suitable feedback control performance and safety of the board 100. This may be done through a motor power algorithm 308, as described in context of FIG. 5. For example, there may be different PID zones based on sensor data as well as the remote control 140 throttle position, and the motor power algorithm may calculate and send a stronger or weaker motor power command.

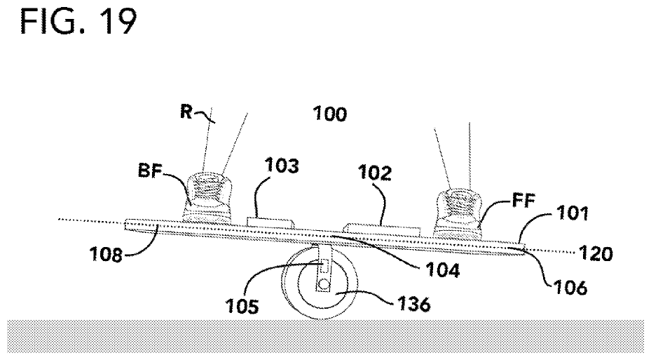

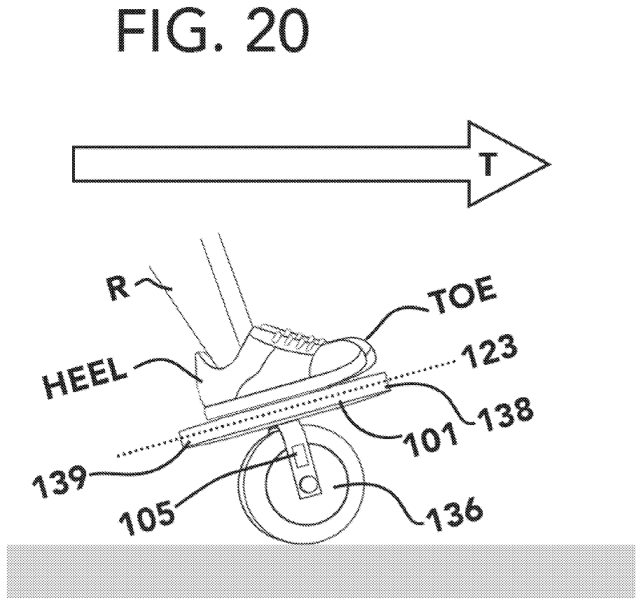

The feedback control loop may be configured to drive the motor 129 to reduce an angle (e.g. tilt angle or roll angle) of the platform 101 with respect to the ground. For example, if in FIG. 19 the rider was to angle the platform 101 downward, so that the front platform portion 106 was lower than the back platform portion 108, then the feedback loop may drive the motor 129 to cause clockwise rotation of the roller 130 about the pitch axis 123 (see FIG. 19) and a counter-clockwise force on the platform 101. In another example, if in FIG. 20 the rider travels in a direction T and was to angle the platform 101 downward, so that a heel side edge 139 was lower than a toe side edge 138, then the feedback loop may drive the motor 129 to cause counter-clockwise rotation of the roller 130 about pitch axis 123 (see FIG. 19) and a clockwise force on the platform 101.

Therefore, some motion of the board 100 may be achieved by the rider leaning their weight toward their front foot FF in FIG. 19 or their toe side edge 138 in FIG. 20. Similarly, deceleration may be achieved by the rider leaning toward their back foot BF in FIG. 19 or leaning towards their heel side edge 139 in FIG. 20. Regenerative braking can be used to slow the board 100 and power the power source 102 (e.g., a rechargeable battery or capacitor). Sustained reverse operation may be achieved by the rider maintaining their lean toward their back foot BF in FIG. 19 or heel side edge 139 in FIG. 20.

FIG. 2 shows a frontal view or a rear view of an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the ability to rotate the board 100 in 360 degrees with respect to the motor assembly 136 or vice versa also allows for a drifting feeling similar to a snowboard if the rider orientation may be perpendicular to the direction of motion. FIG. 2 shows an example of a roll angle of 0 degrees. For example, if in FIG. 20 the rider was to angle the platform 101 downward while riding in the direction of travel T, so that the toe side edge 138 was ‘lower’ than the heel side edge 139 (e.g., if the rider pivoted the platform 101 clockwise about the roll axis 121), then the feedback loop may drive the motor assembly 136 to cause clockwise rotation of the roller 130 and a counter-clockwise force on the platform 101 or vice versa. Thus, motion of the board 100 may be achieved by the rider leaning their weight toward their toes and the front of their body. Similarly, deceleration may be achieved by the rider leaning toward their heels or the back of their body. Regenerative braking may also slow the board and power the power source 102 (e.g., a rechargeable battery or capacitor). Sustained reverse operation may be achieved by the rider maintaining their lean toward their heels or back of their body.

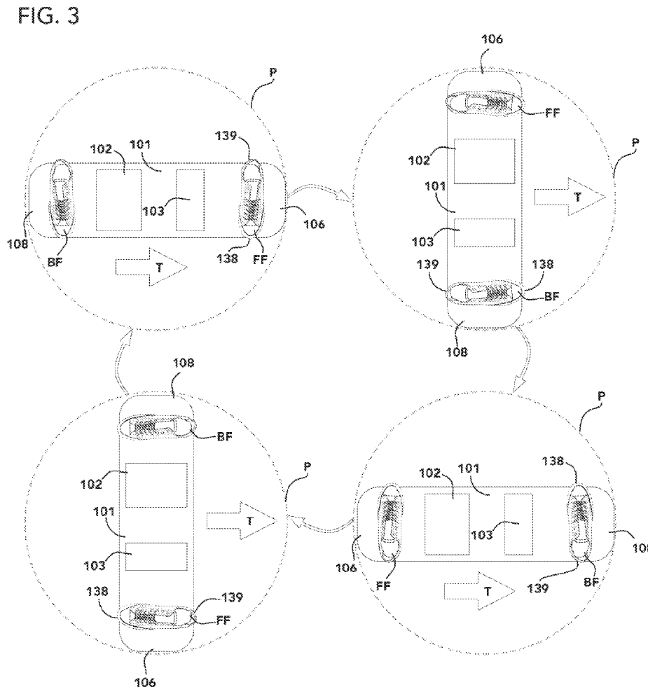

FIG. 3 shows a top view in four configurations of an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the ability to rotate the board 100 in 360 degrees with respect to the motor assembly 136 or vice versa may be further illustrated in FIG. 3, showing four phases of a counter-clockwise 360 degree spin while maintaining a constant direction of travel T, as further illustrated in FIG. 20. The direction of travel T may be constant, while the ends of the platform 101, the front end 106 and the back end 108 rotate along the path P in 360 degrees. The ability for platform 101 to rotate into any position along the path P while maintaining the same direction of travel T may be what mimics or simulates a drifting feeling and 360 degree motion of a snowboard, yet on the ground surface (e.g., a paved road). For example, when the rider does a 360 degree spin while maintaining a constant direction of travel T, the back foot may temporarily become the leading foot position halfway through the spin at the 180 degree point of the spin, then the front foot may return to the leading foot position when the 360 degree spin is complete. Similarly, the toe side edge 138 may become the leading edge at the 90 degree point of the spin, while the heel side edge 139 will become the leading edge at the 270 degree point of the spin.

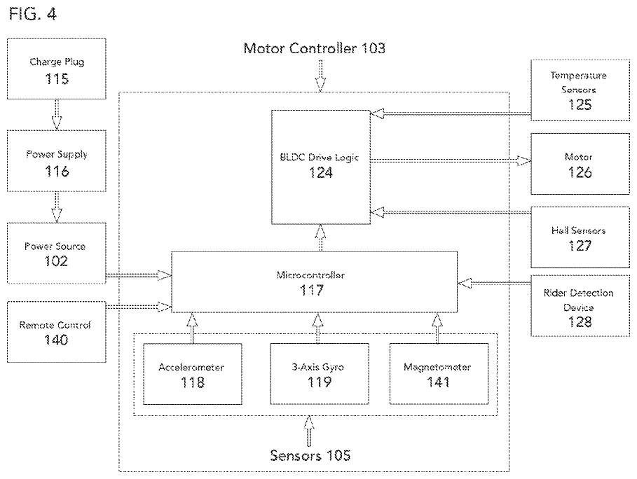

FIG. 4 shows a block diagram of electrical components of a vehicle. Some elements of this figure are described above. Thus, same reference characters identify identical and/or like components described above and any repetitive detailed description thereof will hereinafter be omitted or simplified in order to avoid complication. In particular, the electrical components in FIG. 4 may include a brushless direct current (BLDC) drive logic 124, a 3-axis accelerometer 118, a 3-axis gyro 119, a magnetometer 141, a hall sensor(s) 127, the remote control 140, a charge plug 115, a power supply 116, a power source 102, a microcontroller 117, a rider detection device 128, a motor 129, a temperature sensor 125. The BLDC drive logic 124 may be included in and/or operably, electrically, or logically connected to controller 103. The microcontroller 117 may be included in and/or operably, electrically, or logically connected to controller 103. The accelerometer 118, the 3-axis gyro 119, and the magnetometer 141 may be included in sensor(s) 105. The sensor(s) 105 may be included in and/or operably, electrically, or logically connected to the controller 103.

Active balancing (or self-stabilization) of the board 100 may be achieved through the use of a feedback control loop or mechanism, which may be implemented in the electrical components. The feedback control mechanism may include the sensor(s) 105 connected to (and/or included in) the controller 103.

The microcontroller 117 comprises a hardware processor, such as a single core chip or a multi-core chip, and a memory, such as non-volatile memory, for instance flash memory, operably coupled to the processor. The memory may store a set of instructions for execution by the processor, whether serially and/or in parallel. For example, the processor and the memory can be installed in a controller unit coupled to the platform 101. Such as via mating, adhering, fastening, or interlocking. The controller unit may comprise a transceiver operably coupled to the processor and an antenna operably coupled to the transceiver for wireless communication with the remote control 140. Such as via a short-range wireless communication protocol. Such as infrared based and/or radio frequency (RF) based. In some embodiments, the controller unit includes a receiver alternative to the transceiver. The set of instructions may be instructive to assist in board traction control in order to optimize a riding speed of at least one of the motor assembly 136 relative to a specific rider input, such as a setting. Some examples of such setting comprise fast speed, slow speed, extreme speed, high performance speed, or some other setting level that controls traction, acceleration, speed, and/or control. The set of instructions may be instructive to process a set of inputs, which can comprise a first motor speed, a first motor electrical current, a second motor speed, a second motor electrical current, a user setting, or a remote control potentiometer level. The set of instructions may be instructive to provide a set of outputs, which can control at least one of a first motor speed, a first motor acceleration, a first motor current, a second motor speed, a second motor acceleration, and a second motor current, for at least one of the motor(s) 129. In some embodiments, the set of outputs can also control each of the motor(s) 129 independently so that only one motor 129 can be used at a time, if necessary (e.g., to preserve battery).

As indicated in FIG. 4, the microcontroller 117 may be configured to send a signal to the BLDC drive logic 124, which may communicate information relating to the orientation, direction of travel and motion of platform 101. The BLDC drive logic 124 may then interpret the signal and drive the motor 129 accordingly. The hall sensor(s) 127 may send a signal to the BLDC drive logic 124 to provide feedback regarding a substantially instantaneous rotational rate of the rotor of the motor 129. The temperature sensor 125 may be configured to measure a temperature of the motor 129 and send this measured temperature to the BLDC drive logic 124. The BLDC drive logic 124 may limit an amount of power supplied to the motor 129 based on the measured temperature of the motor 129 to prevent motor 129 from overheating.

Certain modifications to the PID loop or other suitable feedback control loop may be incorporated to improve performance and safety of the board 100. For example, integral windup may be prevented by limiting a maximum integrator value, and an exponential function may be applied to a pitch error angle (e.g., a measure or estimated pitch angle of the platform 101) or roll error angle (e.g., a measure or estimated roll angle of the platform 101).

Alternatively or additionally, some embodiments may include neural network control, fuzzy control, genetic algorithm control, linear quadratic regulator control, state-dependent Riccati equation control or other control algorithms. In some embodiments, absolute or relative encoders may be operably incorporated to provide feedback on motor position.

Once the rider has suitably positioned themselves on the board 100, the control loop may be configured to not activate until the rider moves the board 100 to a predetermined orientation. For example, an algorithm may be incorporated into the feedback control loop. Such that the control loop may be not active (e.g., does not drive the motor) until the rider uses their weight to bring the board up to an approximately level orientation (e.g., 0 degree pitch angle—as shown in FIG. 1 or a 0 degree roll angle—as shown in FIG. 2). Once this predetermined orientation may be detected, the feedback control loop may be enabled (or activated) to balance the board and to facilitate a transition of the board from a stationary mode (or configuration, or state, or orientation) to a moving mode (or configuration, or state, or orientation).

The board 100 may include safety mechanisms, such as the rider detection device 128, to ensure that the rider may be on the board before engaging the feedback control loop. In some embodiments, the rider detection device 128 may be configured to determine if the rider's feet are disposed on the platform 101, and to send a signal causing the motor 129 to enter an active state when the rider's feet are determined to be disposed on the platform 101.

The rider detection device 128 may include any suitable mechanism, structure, or apparatus for determining whether the rider may be on the board. For example, the rider detection device 128 may include a mechanical button, a mechanical lever, a capacitive sensor, an inductive sensor, an optical switch, a force resistive sensor, a load cell, a strain gauge, a magnet, or other suitable devices. There may be a single rider detection device 128 or a set of rider detection devices 128, which may operate independently or dependent on each other. For example, the mechanical buttons may be located on or under either or both of portions 106, 108 (see FIG. 1). For example, the mechanical buttons may be pressed directly (e.g., if on the deck portions 106, 108), or indirectly (e.g., if under the deck portions 106, 108), to sense whether the rider may be on the platform 101. The rider detection device 128 may include the capacitive sensor and/or the inductive sensor may be located on or near a surface of either or both of the deck portions 106, 108, and may correspondingly detect whether the rider may be on the board via a change in capacitance or a change in inductance.

Similarly, the optical switch may be located on or near the surface of either or both of the deck portions 106,108. The optical switch may detect whether the rider may be on the board based on an optical signal. The strain gauge may be configured to measure board or axle flex imparted by the rider's feet to detect whether the rider may be on the board.

In some embodiments, the rider detection device 128 may include a hand-held “dead-man’ switch. For example, the “dead-man” switch may be located on the remote control 140. If the rider detection device 128 detects that the rider may be suitably positioned on the board, then the rider detection device 128 may send a rider-present signal to microcontroller 117. The rider-present signal may be the signal causing motor 129 to enter the active state. In response to the rider-present signal (and/or the board being moved to the level orientation), the microcontroller 117 may activate the feedback control loop for driving the motor 129. For example, in response to the rider-present signal, microcontroller 117 may send board orientation information (or measurement data) from sensor(s) 105 to the BLDC drive logic 124 for powering the motor 129. In some embodiments, if the rider detection device 128 detects that the rider may be no longer suitably positioned or present on the board, then the rider detection device 128 may send a rider-not-present signal to the microcontroller 117. In response to the rider-not-present signal, circuitry of the board 100 (e.g., microcontroller 117, the BLDC Drive Logic 124) may be configured to reduce a rotational rate of the rotor in the motor 129 relative to the stator to bring the board 100 to a stop. For example, the electric coils of the rotor in the motor 129 may be selectively powered to reduce the rotational rate of the rotor in the motor 129.

In some embodiments, in response to the rider-not present signal, the circuitry may be configured to energize the electric coils with a relatively strong and/or substantially continuously constant voltage, to lock the rotor relative to the stator, to prevent the rotor from rotating relative to the stator, and/or to bring the rotor to a sudden stop. In some embodiments, the board may be configured to actively drive the motor 129 even though the rider may not be present on the board 100 (e.g., temporarily), which may allow the rider to perform various tricks. For example, the rider detection device 128 may be configured to delay sending the rider-not-present signal to the microcontroller for a predetermined duration of time, and/or the microcontroller may be configured to delay sending the signal to the BLDC Drive Logic 124 to cut power to the motor for a predetermined duration of time.

The power supply 116 may be connected between the charge plug 115 and the power source 102. The rider (or other user) may couple the power supply 116 to the charge plug 115 and re-charge the power source 102.

FIG. 5 shows a flowchart of a method performed by and/or in conjunction with a vehicle according to this disclosure. Some elements of this figure are described above. Thus, same reference characters identify identical and/or like components described above and any repetitive detailed description thereof will hereinafter be omitted or simplified in order to avoid complication. In particular, a method 300 may be performed by the controller 103 (e.g., the microcontroller 117) in real-time when the rider is riding the board 100. Although various steps of method 300 are described below and depicted in FIG. 5, the steps need not necessarily all be performed, and in some cases may be performed in a different order than the order shown.

As shown, the method 300 may include an initialization procedure, which is optional. The initialization procedure may include a step 301 of detecting the rider R. For example, the controller 103 may determine whether the rider may be detected as being suitably positioned on the platform 101 (e.g., with one foot on back platform portion 108, and the other foot on front platform portion 106, as shown in FIG. 1), based on a received signal from the rider detection device 128. If it may be determined at step 301 that the rider may be not detected on the board, then step 301 may be repeated until a rider may be detected.

At step 301, if the controller 103 determined that the rider is not detected (e.g., has fallen, jumped, or otherwise dismounted the electric vehicle), then the operation procedure may flow to a step 302 of stopping the motor 129, and return to step 301. At step 302, stopping the motor 129 may involve locking the rotor relative to the stator in motor 129, such that the roller 130 stops rotating. For example, at step 302, the motor controller 103 may energize the electric coils of the stator on motor 129 with a substantially continuous, constant, and/or relatively strong electric current to produce a substantially constant and/or strong electromagnetic field for stopping rotation of the magnets of the rotor relative to the stator in the motor 129.

In some embodiments, the rider detection device 128 may substantially continuously send the rider-present signal to the circuitry when the rider may be positioned on the board, and/or may substantially continuously send the rider-not-present signal to the circuitry when the rider may be not positioned on the board. In some embodiments, the rider detection device 128 may intermittently send these signals based on the position of the rider. If it may be determined at step 301 that a rider may be detected as suitably positioned on the platform 101, as may be shown in FIG. 1, then the standby procedure may flow to a step 303 of reading or acquiring a measurements (e.g., orientation information) from sensor(s) 105 (e.g., gyro, magnetometer and accelerometer).

The method 300 may include a step 303 of reading or acquiring measurements from the sensor(s) 105. For example, at step 303, the controller 103 (or other circuitry) may acquire acceleration measurements of the platform 101 or the mount 131 along the pitch, roll, and yaw axes from an accelerometer in the sensor(s) 105, and may acquire position measurements of the platform 101 or the mount 131 about the pitch, roll, and yaw axes from a gyro in sensor(s) 105.

The method 300 may include a step 304 of reading the throttle level. The throttle level may be generated by the remote control 140. The throttle level may also be generated by pressure sensors on the sensor(s) 105 that may read the weight distribution of Rider R.

The method 300 may include a step 305 of determining if the board 100 may be in an orientation that will generate a PID calculation. This determination may use measurements from the sensor(s) 105 acquired at step 303 (including or not including the applied offsets) with the complementary or Kalman filter. For example, the method may allow PID control if a rotary encoder 107 real-time reports (e.g., wired connection) a reading from about 15 degrees inclusive to about 175 degrees inclusive to the controller 103. For example, the method may allow PID control if the sensor(s) 105 real-time reports a roll-axis reading of about 15 degrees inclusively or less. Note that these degrees are illustrative and other amounts or ranges may be used, as needed.

The method 300 may include a step 306 of collecting the sensor(s) 105 values. For example, at step 306, the controller 103 may combine readings from the accelerometer 118 and the gyro 119 in the sensor(s) 105 acquired at step 303 (including or not including the applied offsets) with the complementary or Kalman filter to provide information for the controller 103 to be able to calculate the P, I, and D values for the PID control scheme.

The method 300 may include a step 307 of calculating P.I., and D values for the PID control scheme. These P, I, and D values may be used to filter out impacts from bumps on the ground, road texture, and/or disturbances due to unintentionally sudden steering inputs.

The method 300 may include a step 308 of determining a motor power algorithm. This algorithm may include measurements from the sensor(s) 105 acquired at step 303 (including or not including the applied offsets) with the complementary or Kalman filter (or its equivalent). This algorithm may include measurements from the rotary encoder 107. This algorithm may also include the PID values calculated in step 307. This algorithm may also include the throttle level read in step 304. This algorithm may include measurements from the rider detection device 128. This algorithm may include measurements from the power source 102, which may include energy level remaining, battery current, or other power source measurement. This algorithm may include measurements from the motor 129, which may include motor speed, motor current, motor voltage, motor resistance or other electric motor measurement.

For example, the controller 103 (e.g., the microcontroller 117) may run the algorithm to generate or contain a set of pre-defined ranges of values, each range of values respectively containing a set of values for a respective real-time reading (e.g., speed, RPM, orientation, positioning, yaw, angle, energy level, rate of energy depletion) respectively obtained from the sensor(s) 105, the rotary encoder 107, the motor 129, the power source 102 and the rider detection device 128. In the aforementioned example, the controller 103 (e.g., the microcontroller 117) may run algorithm to alter the PID values or resultant motor command(s) calculated in step 307 if one or more of those readings mentioned above are determined by the controller 103 (e.g., the microcontroller 117) to be respectively inside or present, inclusively, in the pre-defined range of values respectively for the sensor(s) 105, the rotary encoder 107, and the motor 129, the power source 102, or the rider detection device 128. For example, there may be a range of values for the sensor(s) 105, a range of values for the rotary encoder 107, a range of values for the motor 129, a range of values for the power source 102, and a range of values for the rider detection device 128. Each of these readings may influence the algorithm to a greater or lesser degree, or may not influence the algorithm at all based upon the reading value.

For example, the controller 103 (e.g., the microcontroller 117) may run the algorithm to allow motor commands to come from the throttle level read in step 304 if one or more readings are outside the pre-defined range of values for each of the sensor(s) 105, the rotary encoder 107, and the motor 129, the power source 102, or device 128, as explained above.

For example, the controller 103 (e.g., the microcontroller 117) may run the algorithm to generate a motor command based upon both the throttle level read in step 304 and the PID values calculated in step 307 if one or more readings are near the pre-defined range of values for each of the sensor(s) 105, the rotary encoder 107, and the motor 129, the power source 102, or the rider detection device 128, as explained above.

Likewise, if one or more of those readings mentioned above are determined by the controller 103 (e.g., the microcontroller 117) to be not respectively inside or present, inclusively, in the pre-defined range of values respectively for the sensor(s) 105, the rotary encoder 107, the motor 129, the power source 102, or the rider detection device 128, then the controller 103 (e.g., the microcontroller 117) may run the algorithm mentioned above or another algorithm to alter the PID values or resultant motor command(s) calculated in step 307. Note that hybrid scenario is possible where some values are present in some ranges of values and some values are not present in other ranges of values and there is a factor prioritization or conflict resolution algorithm employed by the controller 103 (e.g., the microcontroller 117) as preset in advance to satisfy or not satisfy certain relevant parameters to assist or better assist the rider to ride on the platform 101.

The method 300 may include a step 309 of sending a motor command (or motor control signal) to the motor assembly 136. At step 309, the controller 103 may generate the motor control signal in response to the orientation information received from the sensor(s) 105. The motor assembly 136 may be configured to receive the motor control signal from the controller 103 and to rotate the roller 130 in real-time in response to the orientation information. In another embodiment, at step 309, the controller 103 may generate the motor control signal in response to the motor command from the motor power algorithm generated in step 308. The motor assembly 136 may be configured to receive the motor control signal from the controller 103 and to rotate the roller 130 in real-time in response to the motor command from the controller 103 running the motor power algorithm, with the motor command being generated in step 308.

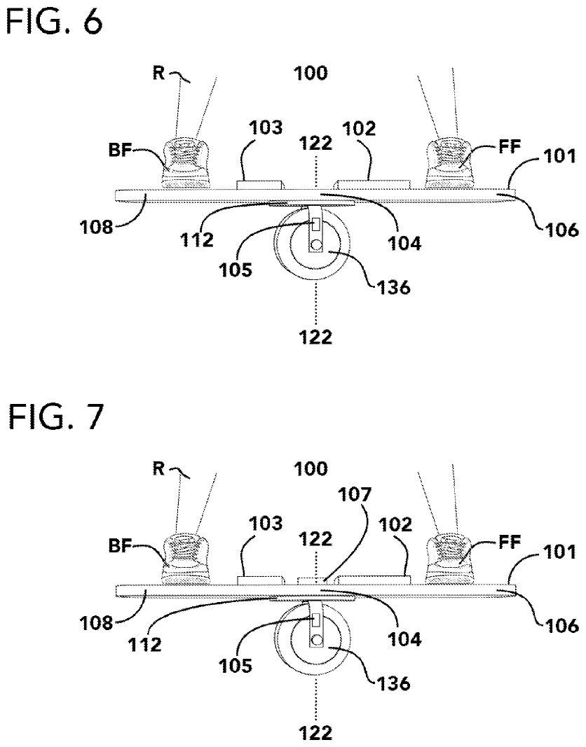

FIG. 6 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may use a slip ring 112 to transfer energy across the electrical circuitry from the power source 102 to the motor assembly 136 so that motor power will continue uninterrupted while the platform 101 continues to rotate about the yaw axis 122 with respect to the motor assembly 136.

FIG. 7 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may include the rotary encoder 107, whether analog or digital, to measure in real-time a rotational angle of the platform 101 (or the mount 131) about the yaw axis 122 extending through the platform 101 with respect to the motor assembly 136 (or the platform 101) while the rider rides the board 100. The rotary encoder 107 may be powered by the power source 102 and controlled by the controller 103. The rotary encoder 107 may include a stator and a rotor. The stator may be positioned on the platform 101 and the rotor may be positioned on the mount 131, or vice-versa. The rotary encoder 107 may be absolute or incremental. The rotary encoder 107 may be mechanical, optical, magnetic, or of another suitable modality. The rotary encoder 107 may generate, read, or obtain the angular position of the stator or the rotor in real-time or motion of the stator or rotor in real-time, and may convert this reading in real-time to analog or digital output signals to send to the controller 103 (e.g., the microcontroller 117). As explained in context of FIG. 5, the rotary encoder 107 may contribute to the sensor values 306 in method 300 (see FIG. 5) to assist or better assist the rider in riding the board 100 (e.g., adjusting the motor assembly 136 or the motor 129). For example, the controller 103 may take an action, issue a command, or adjust the rotational speed of the motor 129 based on the angle of rotation between the platform 101 and the mount 131 or the angular position noted above, to assist the rider to balance on the platform 101 on at least two axis (e.g. pitch and roll, yaw and pitch, roll and yaw, pitch, roll, and yaw) while riding, as disclosed herein, while the roller is rolling.

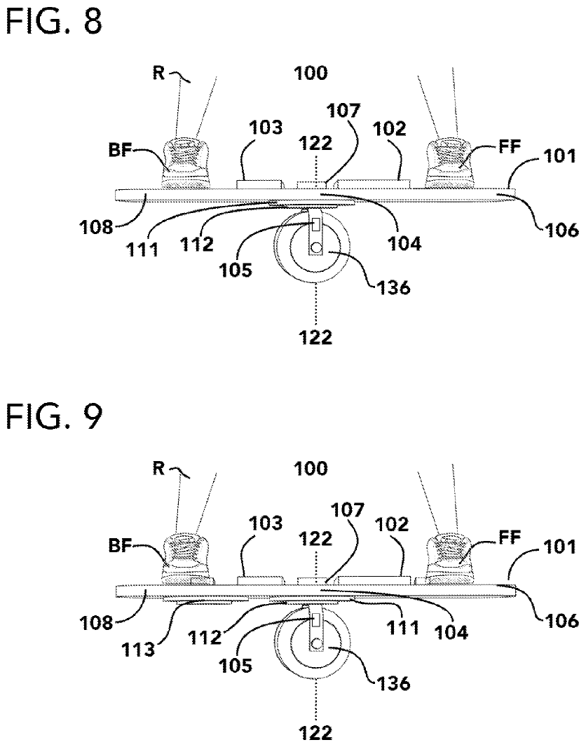

FIG. 8 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may include a second motor 111 to control the orientation of the platform 101 with respect to the motor assembly 136 along the axis 122. The second motor 111 may be used in conjunction with the slip ring 112 and controlled by the controller 103 and powered by the power source 102.

FIG. 9 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may include a gyroscope 113 having a speed, an angle, and a rotation in operation. The gyroscope 113 may be located on, above or below the platform 101 (e.g., secured thereto). The gyroscope 113 may spin clockwise or counterclockwise rotational direction via an internal motor to generate a force to help the rider R maintain balance. The gyroscope 113 may spin at a specific angle via an internal motor to generate a force to further assist the rider to balance on the platform 101 while the roller is rolling. The speed, angle and rotational direction of the gyroscope 113 may be controlled by controller 103 and powered by power source 102.

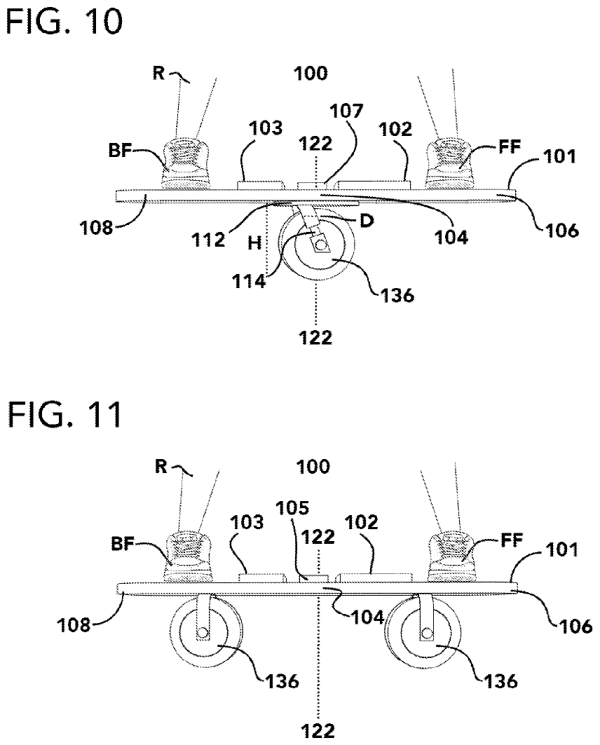

FIG. 10 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may include an actuator 114 (e.g., hydraulic, pneumatic, electric) on the bracket of the motor assembly 136. The actuator 114 is powered by the power source 102 and controlled by the controller 103. The actuator 114 may increase or decrease a height H and/or a trailing distance D of the roller 130 on motor assembly 136 with respect to the platform 111, as shown in FIG. 10, to generate a new configuration to help the rider R maintain balance. For example, the actuator 114 may include a set of telescoping or nested tubes that telescope or nest outward relative to each other to increase the height and telescope or nest inward relative to each other to decrease the height, as controlled by the controller 103 in real-time, which may be based on a reading obtained by the sensor(s) 105 in real-time. Note that this change in the height H or the trailing distance D may also be triggered by the remote control 140.

FIG. 11 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 is similar to the board 100 described in context of FIGS. 1-10, but contains two or more 360 motor assemblies 136, whether identical or not identical to each other in modality. In this configuration, the sensor(s) 105 may be located on platform 101. In this configuration, the sensor(s) 105 may be located on the motor assembly 136. These configurations also feature the same 360 degree maneuverability as demonstrated in FIG. 3. The operational method 300 may also be used, and may also use easing functions to increase or decrease the power in the motor command 309 based upon the rotational angle of each motor assembly 136 with respect to the platform 101 about the yaw axis 122.

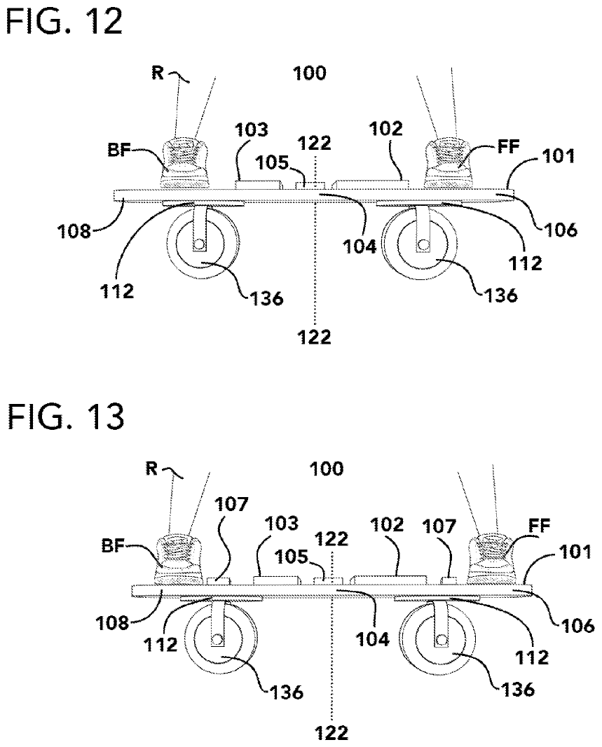

FIG. 12 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may use the slip ring(s) 112, whether identical or not identical to each other in modality, to transfer energy across the electrical circuitry from the power source 102 to the motor assemblie(s) 136 so that motor power will continue uninterrupted while the platform 101 continues to rotate about the yaw axis 122 with respect to the motor assembly 136.

FIG. 13 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may include the rotary encoder(s) 107, whether analog or digital, to measure in real-time a rotational angle of the platform 101 about the yaw axis 122 extending through the platform 101 with respect to the motor assembly 136 while the rider rides the board 100. The rotary encoder(s) 107 may be powered by the power source 102 and controlled by the controller 103. Each of the rotary encoder(s) 107 may include a stator and a rotor, where the stator may be respectively positioned on the platform 101 and the respectively rotor may be positioned on the mount 131, or vice-versa. The rotary encoder 107 may be absolute or incremental. Each of the rotary encoder 107(s) may be mechanical, optical, magnetic, or of another suitable modality, whether identical or not identical to each other in modality. The rotary encoder(s) 107 may respectively generate, read, or obtain the angular position of the stator or the rotor in real-time or motion of the stator or rotor in real-time, and may convert this reading in real-time to analog or digital output signals to send to the controller 103 (e.g., the microcontroller 117). As explained in context of FIG. 5, the rotary encoder(s) 107 may contribute to the sensor values 306 in method 300 (see FIG. 5) to assist or better assist the rider in riding the board 100 (e.g., adjusting the motor assemblie(s) 136 or the motor(s) 129). For example, the controller 103 may take an action, issue a command, or adjust the rotational speed of the motor(s) 129 based on the angle of rotation between the platform 101 and the mount(s) 131 or the angular position noted above, to assist the rider to balance on the platform 101 on at least two axis (e.g. pitch and roll, yaw and pitch, roll and yaw, pitch, roll, and yaw) while riding, as disclosed herein, while the roller is rolling.

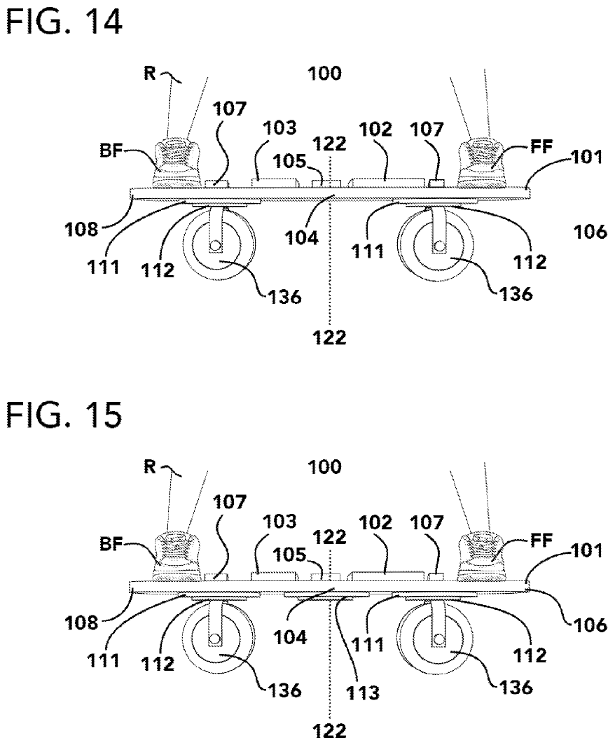

FIG. 14 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may include a third and/or a fourth motor(s) 111, whether identical or not identical to each other in modality, to control the orientation of the platform 101 with respect to the motor assembly 136 along the axis 122. The motor(s) 111 may be respectively used in conjunction with the slip ring 112 and controlled by the controller 103 and powered by the power source 102.

FIG. 15 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may include the gyroscope(s) 113, whether identical or not identical to each other in modality, each having a speed, an angle, and a rotation in operation. The gyroscope(s) 113 may be respectively located on, above or below the platform 101. The gyroscope(s) 113 may each spin clockwise or counterclockwise rotational direction via an internal motor to generate a force to help the rider R maintain balance. The gyroscope(s) 113 may each spin at a specific angle via an internal motor to generate a force to further assist the rider to balance on the platform 101 while the roller is rolling. The respective speed, angle and rotational direction of the gyroscope(s) 113 may be controlled by the controller 103 and powered by the power source 102.

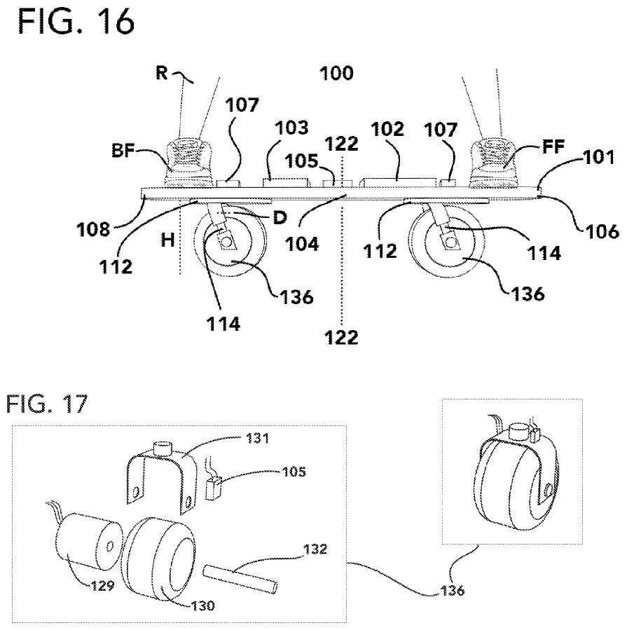

FIG. 16 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may include the actuator(s) 114 (e.g., hydraulic, pneumatic, electric), whether identical or not identical to each other in modality, on the bracket of the motor assembly 136. The actuator(s) 114 are powered by the power source 102 and controlled by the controller 103. The actuator(s) 114 may respectively increase or decrease the height H and/or the trailing distance D of the roller 130 on the motor assembly 136 with respect to the platform 111, as shown in FIG. 16, to generate a new configuration to help the rider R maintain balance. For example, the actuator(s) 114 may each include a set of telescoping or nested tubes that telescope or nest outward relative to each other to increase the height and telescope or nest inward relative to each other to decrease the height, as controlled by the controller 103 in real-time, which may be based on a reading obtained by the sensor(s) 105. Note that this change in the height H or the trailing distance D may also be triggered by the remote control 140.

FIG. 17 shows an assembled view and an exploded view of an example embodiment of a motor assembly according to this disclosure. Some elements of this figure are described above. Thus, same reference characters identify identical and/or like components described above and any repetitive detailed description thereof will hereinafter be omitted or simplified in order to avoid complication. In particular, the motor assembly 136 comprises the mount 131. Although the mount 131 is U-shaped or Y-shaped, the mount 131 can be shaped differently, such as a lattice, a hemisphere, an L-shape, a J-shape, a T-shape, or other suitable shapes. The mount 131 may be unitary (e.g., monolithic) and/or an assembly. The mount 131 may comprise at least one of plastic, metal, rubber, wood, and glass, or any combinations thereof. The mount 131 may be attached, connected, secured or otherwise operably coupled to the roller 130. The roller 130 comprises at least one of plastic, metal, rubber, wood, and glass, or any combinations thereof. The roller 130 can comprise a tire, which is optional. Although the roller 130 is shown as a wheel, in some embodiments, the roller 130 may be embodied as a sphere.

The roller 130 may be operably attached to the motor 129 (or any other suitable mover). The motor 129 may be a brushed motor, a brushless motor, a hub motor, a direct drive, a planetary gear drive, attached by a timing belt to the roller 130, or be otherwise operably coupled. The motor 129 may be operably attached to the mount 131 by an axle 132. Although the axle 132 is a shaft, in some embodiments, the axle 132 may be pair of horns extending towards each other or away from each other. In some embodiments, the motor 129 may have a stator attached to the mount 131. The mount 131 may be operably attached to the platform 101 (e.g., fastened, mated). In some embodiments, the mount 131 may be attached to a bearing inside a bearing housing, and the bearing housing may be attached (e.g., fastened, mated) to the platform 101. The temperature sensor 125 may read the temperature of the motor 129. The motor assembly 136 may be attached (e.g., fastened, mated) to the platform 101. A wire assembly may contain wires from the motor 129, the temperature sensor 125, and/or the hall sensor(s) 127. The wire assembly may operably connect to the controller 103. In some embodiments, the motor assembly 136 may contain multiple rollers 130 and multiple motors 129, or a single roller 130 and a single motor 129, or a single roller 130 with multiple motors 129, or multiple rollers 130 with a single motor 129.

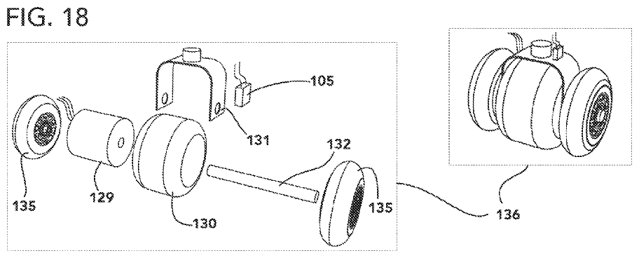

FIG. 18 shows an assembled view and an exploded view of an example embodiment of a motor assembly according to this disclosure. Some elements of this figure are described above. Thus, same reference characters identify identical and/or like components described above and any repetitive detailed description thereof will hereinafter be omitted or simplified in order to avoid complication. In particular, the motor assembly 136 comprises the mount 131. Although the mount 131 may be U-shaped or Y-shaped, the mount 131 can be shaped differently, such as a lattice, a hemisphere, an L-shape, a J-shape, a T-shape, or other suitable shapes. The mount 131 may be unitary (e.g., monolithic) and/or an assembly. The mount 131 may comprises at least one of plastic, metal, rubber, wood, and glass, or any combinations thereof.

The mount 131 may be operably attached (e.g., fastened, mated) to the roller 130. The roller 130 may comprise at least one of plastic, metal, rubber, wood, and glass, or any combinations thereof. The roller 130 may comprise a tire, which is optional. Although the roller 130 is shown as a wheel, in some embodiments, the roller 130 may be embodied as a sphere.

The roller 130 may be operably attached to the motor 129 (or any other suitable mover). The motor 129 may be a brushed motor, a brushless motor, a hub motor, a direct drive, a planetary gear drive, or attached by a timing belt to the roller 130, or be otherwise operably coupled. Although the axle 132 is a shaft, in some embodiments, the axle 132 may be pair of horns extending towards each other or away from each other. In some embodiments, the motor 129 may have a stator attached to the mount 131. The mount 131 may be attached to the platform 101 (e.g., fastened, mated). In some embodiments, the mount 131 may be attached to a bearing inside a bearing housing, and the bearing housing may be attached (e.g., fastened, mated) to the platform 101. The temperature sensor 125 may read the temperature of the motor 129. The motor assembly 136 may be attached (e.g., fastened, mated) to the platform 101. A wire assembly may contain wires from the motor 129, the temperature sensor 125, and/or the hall sensor(s) 127. The wire assembly may operably connect to the controller 103. In some embodiments, the motor assembly 136 may contain multiple rollers 130 and multiple motors 129, or a single roller 130 and a single motor 129, or a single roller 130 with multiple motors 129, or multiple rollers 130 with a single motor 129.

The motor assembly 136 may include a side wheel 135 operably attached to the axle 132 or the mount 131, lateral to the roller 130. The side wheel 135 may be a freely rotating wheel, or may host or contain, whether externally or internally, a motor to drive the side wheel 135, which may be powered by the power source 102 and controller by the controller 103. For example, this motor may be embodied as the motor 129. For example, the side wheel 135 may host the motor driving the side wheel 135, which may include driving the roller 130 as well or not driving or not being coupled to drive the roller 130. For example, the side wheel 135 may host the motor driving the roller 130, which may include driving the side wheel 135 as well or not driving or not being coupled to drive the side wheel 135. For example, the side wheel 135 may be a freely rotating wheel. The side wheel 135 may comprise a tire, which is optional. Although the side wheel 135 is shown as a wheel, in some embodiments, the side wheel 135 may be embodied as a sphere. The motor assembly 136 may contain multiple side wheel(s) 135, on either side of the roller 130. For example, the roller 130 may extend between at least two side wheels 135 or there may be one side wheel 135 lateral to the roller 130.

FIG. 19 shows an example embodiment of a vehicle in according to this disclosure. Some elements of this figure are described above. Thus, same reference characters identify identical and/or like components described above and any repetitive detailed description thereof will hereinafter be omitted or simplified in order to avoid complication. In particular, the board 100 may be in a tilted position with the front portion 106 being lower relative to the ground surface than the back portion 108, as explained above in context of FIG. 1-10. Note that the front portion 106 and the back portion 108 may be reversed depending on how the rider rides the board 100 such that the front portion 106 becomes the back portion 108 and the back portion 108 becomes the front portion 106. Similar state of being may occur with lateral sides of the board 100.

FIG. 20 shows an example embodiment of a vehicle travelling in a direction of travel according to this disclosure. Some elements of this figure are described above. Thus, same reference characters identify identical and/or like components described above and any repetitive detailed description thereof will hereinafter be omitted or simplified in order to avoid complication. In particular, the board 100 may be in a tilted position traveling along a direction T with the toe edge 138 higher than the heel edge 139, as explained in context of FIGS. 1-10. Note that one lateral side of the board 100 is now frontal and one lateral side of the board 100 is now rear.

FIG. 21 shows an example embodiment of a vehicle according to this disclosure. Some elements of this figure are described above. Thus, same reference characters identify identical and/or like components described above and any repetitive detailed description thereof will hereinafter be omitted or simplified in order to avoid complication. In particular, the board 100 may have the roll axis be represented by the roll axis 121 extending through the board 100. Likewise, the board 100 may have the yaw axis be represented by the yaw axis 122 extending through the board 100. Similarly, the board 100 may have the pitch axis be represented by the pitch axis 123 extending through the board 100.

Various embodiments of this disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

This disclosure may be embodied in a system, a method, and/or a computer program product. The computer program product may include a computer readable storage medium (or media) having computer readable program instructions thereon for causing a processor to carry out aspects of this disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of this disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of this disclosure.

Aspects of this disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure.

The flowchart and block diagrams in the figures illustrate the architecture, functionality, and operation of possible implementations of systems, methods, and computer program products according to various embodiments of this disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although various embodiments have been depicted and described in detail herein, skilled artisans know that various modifications, additions, substitutions and the like can be made without departing from this disclosure. As such, these modifications, additions, substitutions and the like are considered to be within this disclosure.

What is claimed is:

1. A device comprising:
a platform (101) that does not have any trucks coupled thereto and configured for a rider to ride thereon;
a mount (131) coupled to the platform, wherein the mount is configured to freely rotate 360 degrees about a first axis relative to the platform;
a motor (129) coupled to the mount and configured to operate at a rotational speed;
a roller (130) coupled to the motor such that the motor can drive the roller about a second axis distinct from the first axis relative to the platform;
a power source (102) coupled to the platform and powering the motor;
a controller (103) powered by the power source; and
an inertial measurement unit (IMU) (105) coupled to the platform or the mount and powered by the power source, wherein the IMU is configured to obtain a reading while the roller is rolling as the rider rides on the platform and send the reading to the controller while the roller is rolling as the rider rides on the platform such that the controller adjusts the rotational speed to assist the rider to balance on the platform while the roller is rolling.

2. The device of claim 1, further comprising:
a slip ring (112) coupled to the mount or the platform and electrically positioned between the power source and the motor, wherein the slip ring is configured to allow for the mount to freely rotate 360 degrees about the first axis relative to the platform while the power source powers the motor or the IMU through the slip ring.

3. The device of claim 1, further comprising:
a rotary encoder (107) coupled to the platform or the mount and configured to detect an angle of rotation between the platform and the mount while the roller is rolling as the rider rides on the platform, wherein the rotary encoder is coupled to the controller for the controller to have access to the angle of rotation.

4. The device of claim 1, wherein the motor is a first motor, and further comprising:
a second motor (111) having a stator and a rotor, wherein the stator is coupled to the platform and the rotor is coupled to the mount or vice versa, wherein the second motor is configured to adjust an angle of rotation between the platform and the mount when the rider rides on the platform as the roller is rolling, wherein the second motor is powered by the power source and controlled by the controller to adjust the angle of rotation based on the reading.

5. The device of claim 1, further comprising:
a gyroscope (113) having a speed, an angle, and a rotation in operation, wherein the gyroscope is coupled to the platform or the mount, wherein the gyroscope is powered by the power source, wherein the controller is configured to control the speed, the angle, and the rotation based on the reading to further assist the rider to balance on the platform while the roller is rolling.

6. The device of claim 1, further comprising:
an actuator (114) coupled to the platform or the mount and powered by the power source, wherein the actuator is configured to move the platform away or towards the roller when the rider rides on the platform as the roller is rolling.

7. The device of claim 1, wherein the mount is a first mount, wherein the motor is a first motor, wherein the roller is a first roller, wherein the rotational speed is a first rotational speed, and further comprising:
a second mount (131) coupled to the platform, wherein the second mount is configured to freely rotate 360 degrees about a third axis relative to the platform independent of the first mount;
a second motor (129) coupled to the second mount and configured to operate at a second rotational speed independent of the first motor; and
a second roller (130) coupled to the second motor such that the second motor can drive the second roller about a fourth axis distinct from the third axis relative to the platform independent of the first roller, wherein the power source powers the second motor, wherein the IMU is configured to obtain the reading while the second roller is rolling as the rider rides on the platform and send the reading to the controller while the second roller is rolling as the rider rides on the platform such that the controller adjusts the second rotational speed to assist the rider to balance on the platform while the second roller is rolling.

8. The device of claim 7, further comprising:
a slip ring (112) coupled to the first mount, the second mount, or the platform and electrically positioned between the power source and the first motor or the second motor, wherein the slip ring is configured to allow for the first mount or the second mount to freely rotate 360 degrees about the first axis or the third axis respectively relative to the platform while the power source powers the first motor, the second motor, or the IMU through the slip ring.

9. The device of claim 7, further comprising:
a rotary encoder (107) coupled to the platform, the first mount, or the second mount and configured to detect an angle of rotation between the platform and the first mount or the second mount while the first roller or the second roller is rolling as the rider rides on the platform, wherein the rotary encoder is coupled to the controller for the controller to have access to the angle of rotation.

10. The device of claim 7, further comprising:
a third motor (111) having a stator and a rotor, wherein the stator is coupled to the platform and the rotor is coupled to the first mount or the second mount, or vice versa, wherein the third motor is configured to adjust an angle of rotation between the platform and the first mount or the second mount when the rider rides on the platform as the first roller or the second roller is rolling, wherein the third motor is powered by the power source and controlled by the controller to adjust the angle of rotation based on the reading.

11. The device of claim 7, further comprising:
a gyroscope (113) having a speed, an angle, and a rotation in operation, wherein the gyroscope is coupled to the platform, the first mount, or the second mount, wherein the gyroscope is powered by the power source, wherein the controller is configured to control the speed, the angle, and the rotation based on the reading to further assist the rider to balance on the platform while the first roller or the second roller is rolling.

12. The device of claim 7, further comprising:
an actuator (114) coupled to the platform, the first mount, or the second mount and powered by the power source, wherein the actuator is configured to move the platform away or towards the first roller or the second roller when the rider rides on the platform as the first roller or the second roller is rolling.

13. The device of claim 7, wherein the first roller contains the first motor or the second roller contains the second motor.

14. The device of claim 1, wherein the roller contains the motor.

15. The device of claim 1, wherein the mount is a sole mount coupled to the platform.

16. The device of claim 7, wherein the first mount and the second mount are sole mounts coupled to the platform.

17. The device of claim 7, wherein the first roller contains the first motor, wherein the second roller contains the second motor.

18. A method comprising:
sending a device to a rider, wherein the device comprising:
a platform (101) that does not have any trucks coupled thereto and configured for a rider to ride thereon;
a mount (131) coupled to the platform, wherein the mount is configured to freely rotate 360 degrees about a first axis relative to the platform;
a motor (129) coupled to the mount and configured to operate at a rotational speed;
a roller (130) coupled to the motor such that the motor can drive the roller about a second axis distinct from the first axis relative to the platform;
a power source (102) coupled to the platform and powering the motor;
a controller (103) powered by the power source; and
an inertial measurement unit (IMU) (105) coupled to the platform or the mount and powered by the power source; and
instructing the rider to ride the platform such that the IMU obtains a reading while the roller is rolling as the rider rides on the platform and sends the reading to the controller while the roller is rolling as the rider rides on the platform such that the controller adjusts the rotational speed to assist the rider to balance on the platform while the roller is rolling.

19. A method comprising:
causing a rider to receive a device comprising:
a platform (101) that does not have any trucks coupled thereto and configured for a rider to ride thereon;
a mount (131) coupled to the platform, wherein the mount is configured to freely rotate 360 degrees about a first axis relative to the platform;
a motor (129) coupled to the mount and configured to operate at a rotational speed;
a roller (130) coupled to the motor such that the motor can drive the roller about a second axis distinct from the first axis relative to the platform;
a power source (102) coupled to the platform and powering the motor;
a controller (103) powered by the power source; and
an inertial measurement unit (IMU) (105) coupled to the platform or the mount and powered by the power source; and
causing the rider to operate the device such that the IMU obtains a reading while the roller is rolling as the rider rides on the platform and send the reading to the controller while the roller is rolling as the rider rides on the platform such that the controller adjusts the rotational speed to assist the rider to balance on the platform while the roller is rolling.

20. A method comprising:
accessing a device comprising:
a platform (101) that does not have any trucks coupled thereto and configured for a rider to ride thereon;
a mount (131) coupled to the platform, wherein the mount is configured to freely rotate 360 degrees about a first axis relative to the platform;
a motor (129) coupled to the mount and configured to operate at a rotational speed;
a roller (130) coupled to the motor such that the motor can drive the roller about a second axis distinct from the first axis relative to the platform;
a power source (102) coupled to the platform and powering the motor;
a controller (103) powered by the power source; and
an inertial measurement unit (IMU) (105) coupled to the platform or the mount and powered by the power source; and
riding the device such that the IMU obtains a reading while the roller is rolling as the rider rides on the platform and sends the reading to the controller while the roller is rolling as the rider rides on the platform such that the controller adjusts the rotational speed to assist the rider to balance on the platform while the roller is rolling.

21. A method comprising:
manufacturing a device comprising: a platform (101) that does not have any trucks coupled thereto and configured for a rider to ride thereon; a mount (131) coupled to the platform, wherein the mount is configured to freely rotate 360 degrees about a first axis relative to the platform; a motor (129) coupled to the mount and configured to operate at a rotational speed; a roller (130) coupled to the motor such that the motor can drive the roller about a second axis distinct from the first axis relative to the platform; a power source (102) coupled to the platform and powering the motor; a controller (103) powered by the power source; and an inertial measurement unit (IMU) (105) coupled to the platform or the mount and powered by the power source, wherein the IMU is configured to obtain a reading while the roller is rolling as the rider rides on the platform and send the reading to the controller while the roller is rolling as the rider rides on the platform such that the controller adjusts the rotational speed to assist the rider to balance on the platform while the roller is rolling.
